(19) United States
(12) Patent Application Publication
(10) Pub. No.: US 2008/0007760 A1
(43) Pub. Date: Jan. 10, 2008

(54) PRINTING SYSTEM, PRINT RESTRICTING METHOD, AND PROGRAM

(75) Inventor: Hiroyuki KIMURA, Kawasaki-shi (JP)

Correspondence Address: ROSSI, KIMMS & McDOWELL LLP., P.O. BOX 826, ASHBURN, VA, 20146-0826, US

(73) Assignee: CANON KABUSHIKI KAISHA, Tokyo (JP)

(21) Appl. No.: 11/771,071

(22) Filed: Jun. 29, 2007

(30) Foreign Application Priority Data
Jun. 29, 2006 (JP) 2006-180233

(51) Int. Cl. G06K 15/00

(52) U.S. Cl. 358/1.14

(57) ABSTRACT

A printing system which sets user-specific printing restriction not only on users managed by a control server, but also on users not managed by the server. An authentication server stores user-specific printing restriction information concerning a print job. When a user of a thin client gives a print instruction to a metaframe server via the thin client, the metaframe server determines whether or not printing restriction information associated with the user exists in the metaframe server. If the printing restriction information associated with the user does not exist in the metaframe server, the metaframe server requests the authentication server to send the printing restriction information. The metaframe server causes the printing apparatus to carry out printing according to the printing restriction information sent from the authentication server in response to the request made by the metaframe server.

### BACKGROUND OF THE INVENTION

1. Field of the Invention

The present invention relates to a printing system, a print restricting method, and a program, and more particularly to a printing system comprising thin client terminals, a control server that performs information processing based on requests from the thin client terminals, and a printing apparatus, which are interconnected by a network, a print restricting method applied to the printing system, and a program for causing a computer to execute the print restricting method.

2. Description of the Related Art

Conventional network-connected printing apparatuses for office use can be used by any user who can gain access to the network. To avoid this, there has been proposed a printing system which restricts the use of the printing apparatuses by ID card-based access restriction or by password input request.

However, when members of an office come to incessantly change, it becomes necessary to frequently configure the access rights to the printing apparatuses. Further, it takes much time and labor to set an access right on a printing apparatus-by-printing apparatus basis.

As a first solution to these problems, there has been realized a printing system configured to performs printing restriction by utilizing address information, such as IP addresses in the TCP/IP protocol suite. Further, as a second solution to the same, there has been realized a printing system configured to manage the number of sheets to be printed by utilizing a print log.

However, the first solution is a rough one in that it can perform nothing more than restrict the use of a printing apparatus associated with a specific IP address, and hence it is impossible to perform meticulous management e.g. by limiting the number of sheets that a specific user is allowed to print. On the other hand, the second solution is based on a method in which an administrator monitors a log of printing activity stored in a printing apparatus and checks whether unauthorized printing of sheets in a number exceeding a predetermined number has been performed. However, this solution suffers from the problem of significantly increased human costs.

Further, conventionally, as a third solution to the aforementioned problems, there has been proposed a printing system in which an authentication server is provided on a network, and the authentication server restricts printing on a user-by-user basis in response to a print request received from a client (see e.g. Japanese Laid-Open Patent Publication (Kokai) No. 2003-150336).

FIG. 21 is a block diagram of the conventional printing system which can realize printing restriction on a user-by-user basis (user-specific printing restriction).

As shown in FIG. 21, reference numeral 101 designates a host computer (client). The host computer 101 generates image data, then converts the image data into print data, and stores the print data. Reference numeral 102 designates an authentication server that stores user authentication information and printing restriction information. Reference numeral 103 designates a printing apparatus. The printing apparatus 103 receives print data sent from the host computer 101 via a network 104, and carries out printing on sheets by the electrophotographic printing method or the inkjet printing method. The network 104 is a LAN implemented e.g. by an Ethernet®. The host computer 101, the authentication server 102, and the printing apparatus 103 are interconnected by the network 104. The authentication server 102 is provided with a database.

FIG. 22 is a view showing contents of the database provided in the authentication server 102, by way of example. The database stores user-specific authentication information and printing restriction information.

As shown in FIG. 22, each row shows entries associated with a user (user entry), and entries of authentication information and entries of printing restriction information, which are associated with the user, are recorded in the associated fields of respective columns. Reference numeral 201 designates a user name column, 202 a password column, 203 a column for the maximum printable number of sheets, and 204 a column for the actually printed number of sheets. Recorded in each field of the column 203 for the maximum printable number of sheets is the maximum printable number of sheets that the associated user is allowed to print in the current month. Recorded in each field of the column 204 for the actually printed number of sheets is the number of sheets that the associated user has actually printed so far in the current month. It should be noted that although plaintext passwords are shown, by way of example, in the password column 202 in FIG. 22 for convenience of description, respective only one-way hash values of the plaintexts of the passwords are recorded in actuality so as to prevent leakage of the passwords. Authentication is performed by comparison between the hash value of a password input by a user and the entry stored in association with the username of the user. Further, only administrators are authorized to read from and write in the present database.

An entry 211 designates entries associated with a username “User 1”, the password of this entry is a character string “Akd5sj4f”. In the entry 211, the maximum printable number of sheets is 500, which means that the “User 1” is allowed to print 500 sheets per month at the maximum. Further, the actually printed number of sheets is 123, which means that the “User 1” has printed 123 sheets so far this month. Similarly, an entry 212 contains the entries of authentication information and printing restriction information associated with a “User 2”, and an entry 213 contains the entries of authentication information and printing restriction information associated with a “User 3”.

An entry 214 contains the entries of authentication information and printing restriction information associated with a guest user. In the illustrated example, “null” is recorded in the password field, but the maximum printable number of sheets is 0, which means that the guest user is not allowed to print. Whether to provide a guest user entry depends on a system policy.

Next, user-specific printing restriction will be described with reference to FIGS. 21 and 22.

A user inputs a user name and a password so as to log on to the host computer 101. This pair of information items are sent to the authentication server 102, where they are compared with each pair of entries in the user name column 201 and the password column 202 of the database, whereby authentication is performed. When the authentication is successful, the authentication server 102 reads out the values of respective associated entries in the column 203 for the maximum printable number of sheets and the column 204 for the actually printed number of sheets, and sends the values to the host computer 101. For example, if the user is “User 1” and the authentication is successful, the host computer 101 is notified of the maximum printable number of sheets=500 and the actually printed number of sheets=123.

The host computer 101 having received the notification recognizes that, before execution of a print job, that the number of remaining printable sheets is equal to 377 (sheets) (=500 (maximum value)−123 (actually printed number of sheets)). If the number of sheets to be printed according to the print job is not larger than 377, the host computer 101 carries out printing. On the other hand, if the number of sheets to be printed according to the print job is 400, for example, it exceeds the upper limit, and hence the host computer 101 displays a warning message to the user.

FIG. 23 is a view showing an example of a dialog that the host computer 101 displays on a display unit when the number of sheets to be printed according to a print job is larger than the number of printable sheets.

As shown in FIG. 23, reference numeral 301 designates a dialog in which 302 designates a button for executing printing, and 303 a button for canceling execution of the printing. If the user of a thin client presses the button 302, the host computer 101 corrects the number of sheets to be printed to 377 and then carries out printing. If the button 303 is pressed, the print request is canceled.

As described above, according to the third solution, printing restriction is executed on a user-by-user basis.

Further, a network system is known which comprises a metaframe server, thin clients, and a printing apparatus.

In general, a thin client is a client computer for use in a system comprised of thin clients and a metaframe server, and configured such that the metaframe server manages resources, such as application software and files. The thin client has only the minimum functions. More specifically, the thin client is not equipped with an external storage device, such as a hard disk or a USB memory, whereby the thin client is free from security problems which might occur if the thin client were provided with such an external storage device. The network system is configured such that a metaframe functioning as a server is caused to store all data.

Connected to the metaframe server are a plurality of thin clients, from each of which input data, such as coordinate data of a mouse (pointing device), click data from the mouse, and key data from a keyboard, are sent to the metaframe server. The metaframe server sends information for rewriting a screen, job status information, and so forth to the thin client according to the input data therefrom. More specifically, the thin client is only a terminal of the metaframe server, which has a simple configuration formed by a simplified CPU, a memory for temporarily storing information, a ROM, and an input/output device equipped with a communication function. The ROM stores only a control program for data input/output processing. Data processing, job processing, and the like processing are carried out by the metaframe server, and only processing results are sent to an associated thin client. Thus, the metaframe server manages all processing requested from each thin client.

However, when user-specific printing restriction is to be executed by the network system comprising the metaframe server, the thin clients, and the printing apparatus, the following problems occur.

A first problem: In a case where the printing apparatus can be freely caused to print simply by connecting a thin client to the metaframe server, the network system has a problem in terms of security. Further, even if the mounting of an ID card or inputting of a password is required, in a case where the functions of the printing apparatus are permitted to be used simply by mounting the ID card or inputting the password, the network system has a problem in terms of security. To solve the problem, it is envisaged to execute printing restriction for the thin clients under the control of the metaframe server, on a user-by-user basis.

In this case, however, the user-specific printing restriction can be imposed on users under the management of the metaframe server, but not on the other users, such as guest users. Therefore, it cannot be helped but impose uniform printing restriction on the guest users who are not managed by the metaframe server.

A second problem: To enable printing restriction to be set to all users, including guest users, connected to the same network, it is possible to envisage that a management server (authentication server) is provided, and printing restriction information is managed by the management server, as in the above-described third solution. However, concentration of management of the printing restriction information to the single management server (authentication server) is not favorable from the viewpoint of load applied to the server and network traffic. More specifically, before execution of each print job, the metaframe server requests the authentication server to confirm whether printing is permitted, which causes degradation of printing performance. Further, not only load on the authentication server but also network traffic between the metaframe server and the authentication server is increased.

### SUMMARY OF THE INVENTION

The present invention provides a printing system which sets user-specific printing restriction not only on users under the management of a control server capable of managing users, such as a metaframe server, but also on users who are not under the management of the server, a print restricting method applied to the printing system, and a program for causing a computer to execute the print restricting method. Further, the present invention makes it possible not only to reduce network load and load on the control server in execution of the printing restriction, but also to improve printing performance.

In a first aspect of the present invention, there is provided printing system including a thin client terminal, a control server for processing information based on a request from the thin client terminal, and a printing apparatus, which are interconnected by a network, comprising an authentication server connected to the network and configured to store printing restriction information concerning a print job on a user-by-user basis, a determination unit provided in the control server and configured to determine, when a user of the thin client terminal gives a print instruction to the control server via the thin client terminal, whether or not printing restriction information associated with the user exists in the control server, a transmission request unit provided in the control server and configured to request the authentication server to send the printing restriction information associated with the user, when the determination unit determines that the printing restriction information associated with the user does not exist in the control server, and a print control unit provided in the control server and configured to cause the printing apparatus to carry out printing according to the printing restriction information sent from the authentication server in response to the request made by the transmission request unit.

In a second aspect of the present invention, there is provided a print restricting method applied to a printing system including a thin client terminal, a control server for processing information based on a request from the thin client terminal, an authentication server for storing printing restriction information concerning a print job on a user-by-user basis, and a printing apparatus, which are interconnected by a network, comprising a determination step of the control server determining, when a user of the thin client terminal gives a print instruction to the control server via the thin client terminal, whether or not printing restriction information associated with the user exists in the control server, a transmission request step of the control server requesting the authentication server to send the printing restriction information associated with the user, when it has been determined, in the determination step, that the printing restriction information associated with the user does not exist in the control server, and a print control step of the control server causing the printing apparatus to carry out printing according to the printing restriction information sent from the authentication server in response to the request made in the transmission request step.

In a third aspect of the present invention, there is provided a program for causing a computer to execute a print restricting method applied to a printing system including a thin client terminal, a control server for processing information based on a request from the thin client terminal, an authentication server for storing user-specific printing restriction information associated with a print job and a printing apparatus, which are interconnected by a network, wherein the print restricting method comprises a determination step of the control server determining, when a user of the thin client terminal gives a print instruction to the control server via the thin client terminal, whether or not printing restriction information associated with the user exists in the control server, a transmission request step of the control server requesting the authentication server to send the printing restriction information associated with the user, when it has been determined, in the determination step, that the printing restriction information associated with the user does not exist in the control server, and a print control step of the control server causing the printing apparatus to carry out printing according to the printing restriction information sent from the authentication server in response to the request made in the transmission request step.

With the configuration of the present invention, it is possible to put restrictions on a print instruction from a user under the management of the control server, based on the printing restriction information stored in the control server, and to put restrictions on printing on a print instruction from a user who is not under the management of the control server, based on the printing restriction information stored in the authentication server. This makes it possible not only to reduce network load and load on the control server and the authentication server, but also to improve printing performance.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate an embodiment of the present invention and, together with the description, serve to explain the principles of the present invention.

FIG. 1 is a block diagram of a printing system according to a first embodiment of the present invention.

FIG. 2 is a block diagram of a control section that controls the operation of a printing apparatus appearing in FIG. 1.

FIG. 3 is a view useful in explaining the internal configuration of a job packet.

FIG. 4 is a view useful in explaining the configuration of a print job without printing restriction information.

FIG. 5 is a view useful in explaining the configuration of a print job with printing restriction information added thereto.

FIG. 6 is a view showing an example of a format of the printing restriction information.

FIG. 7 is a view of a print job packet with entries of printing restriction information.

FIG. 8 is a view of a GUI screen displayed when a user configures an operation policy via an operating section (GUI unit)

FIG. 9 is a flowchart of a printing restriction ticket-determining process which is executed by a printing restriction ticket-determining unit appearing in FIG. 2.

FIG. 10 is a flowchart (first half) of a packet converting process which is executed by a packet conversion unit appearing in FIG. 2.

FIG. 11 is a flowchart (second half) of the packet converting process.

FIG. 12 is a flowchart of a print data-interpreting process which is executed by a print data interpretation unit appearing in FIG. 2.

FIG. 13 is a flowchart of a print job-canceling process which is executed by a print job cancellation unit appearing in FIG. 2.

FIG. 14 is a flowchart showing a flow of first operations of respective apparatuses forming the printing system shown in FIG. 1.

FIG. 15 is a sequence diagram showing transmission/reception of signals performed between the apparatuses in the printing system, when printing is performed.

FIG. 16 is a flowchart showing a flow of second operations of the respective apparatuses forming the printing system shown in FIG. 1.

FIG. 17 is a sequence diagram showing transmission/reception of signals performed between apparatuses forming a printing system which does not include an authentication server.

FIG. 18 is a sequence diagram showing transmission/reception of signals performed between the apparatuses in the printing system according to the first embodiment.

FIG. 19 is a sequence diagram showing transmission/reception of signals performed between the apparatuses in the printing system in a case where the printing apparatus carries out scanning and copying.

FIG. 20 is a flowchart showing a flow of operations of a printing system according to a second embodiment of the invention, which are carried out for printing.

FIG. 21 is a block diagram of a conventional printing system which can realize user-specific printing restriction.

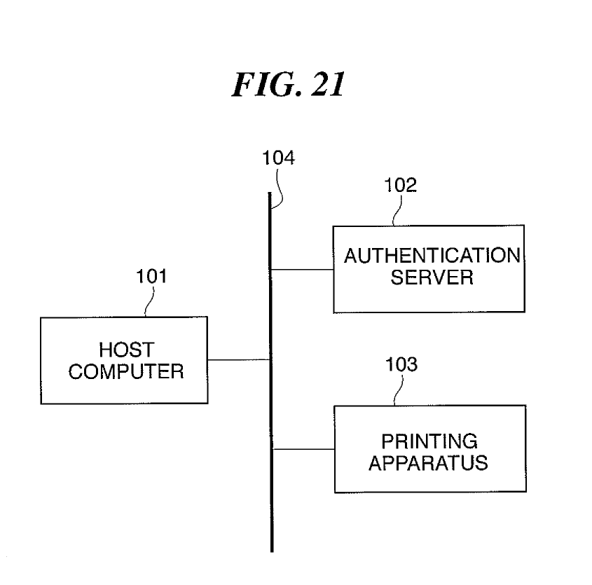

FIG. 22 is a view showing an example of contents of a database provided in an authentication server.

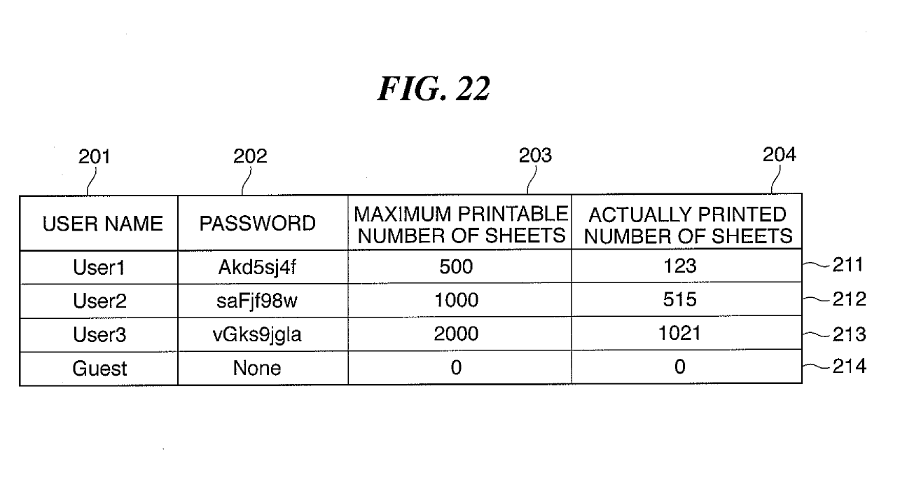

FIG. 23 is a view showing an example of a dialog that a host computer displays on a display unit of a thin client when the number of sheets to be printed according to a print job is larger than the number of printable sheets.

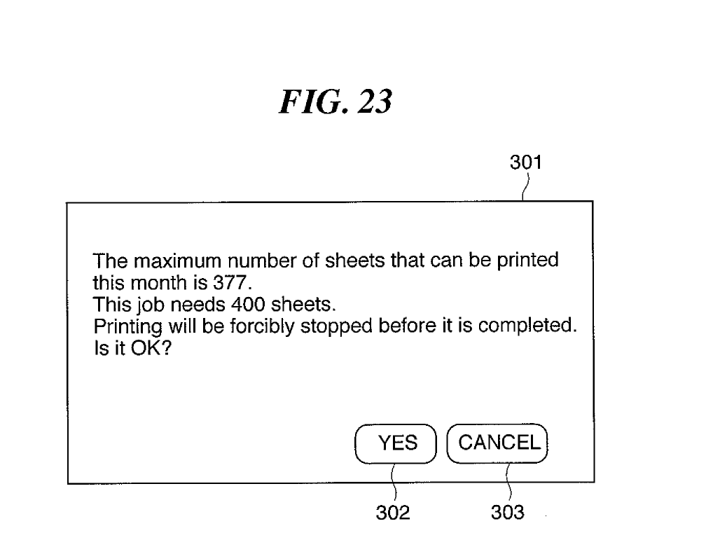

### DETAILED DESCRIPTION OF THE PREFERRED EMBODIMENTS

Preferred embodiments of the present invention will be described in detail below with reference to the drawings.

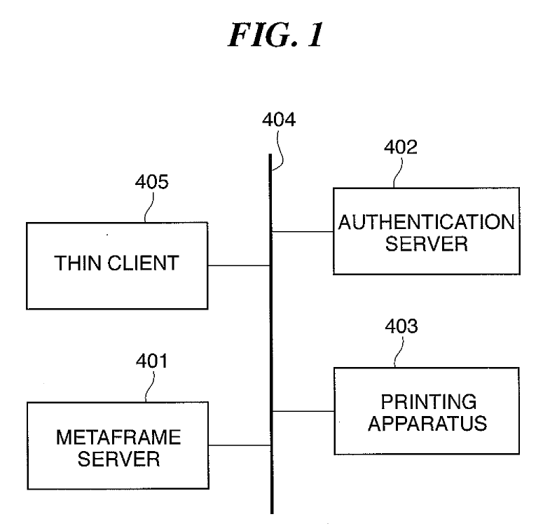

FIG. 1 is a block diagram of a printing system according to a first embodiment of the present invention.

As shown in FIG. 1, reference numeral 401 designates a metaframe server. The metaframe server 401 generates document data or image data according to input operations by a user on a thin client 405, and then converts the data into print data. Reference numeral 402 designates an authentication server that stores user authentication information and printing restriction information. It should be noted that the authentication server 402 stores authentication information and printing restriction information associated with users other than users who give a print instruction via the metaframe server 401. Reference numeral 403 designates a printing apparatus. The printing apparatus 403 receives print data via a network 404, and carries out printing on sheets by the electrophotographic printing method or the inkjet printing method. Although only one thin client 405 is shown in FIG. 1, a plurality of thin clients may be connected to the network 404. Further, ordinary client machines (i.e. clients which can operate without a metaframe server) other than thin clients can also be connected to the network 404. The metaframe server 401, the thin client 405, the authentication server 402, and the printing apparatus 403 are interconnected by the network 404.

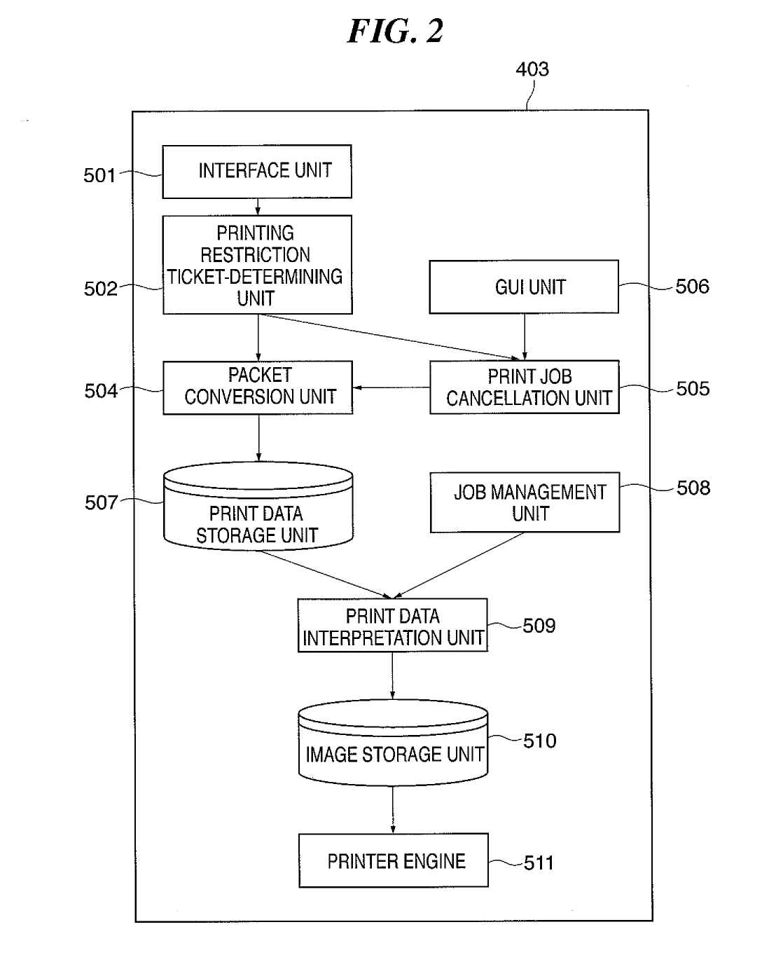

FIG. 2 is a block diagram of a control section that controls operation of the printing apparatus 403 appearing in FIG. 1. The control section is comprised, for example, of a central processing unit (CPU), a ROM (Read Only Memory) that stores a control program executed by the CPU, a RAM (Random Access Memory) used for the operation of the CPU, an external storage device, and an input/output device. Blocks shown in FIG. 2 represent functions realized by execution of the control program by the CPU and functions of the external storage device.

As shown in FIG. 2, reference numeral 501 designates an interface unit. The interface unit 501 establishes connection with the network 404 and receives print jobs via the network 404. Reference numeral 502 designates a printing restriction ticket-determining unit. The printing restriction ticket-determining unit 502 determines the form of a received print job and determines whether or not the print job has a printing restriction ticket added thereto. Reference numeral 504 designates a packet conversion unit. When a print job has a printing restriction ticket added thereto, the packet conversion unit 504 modifies an instruction for the print job, based on printing restriction information, and notifies the corrected instruction to a following processing stage. Reference numeral 505 designates a print job cancellation unit. The print job cancellation unit 505 gives an instruction for canceling printing to be performed according to a print job without the printing restriction ticket added thereto. Reference numeral 506 designates a GUI unit. The GUI unit 506 turns on or off the operation of the print job cancellation unit 505 according to an input operation performed by the user via an operation panel, not shown.

Reference numeral 507 designates a print data storage unit that temporarily stores print data, i.e. PDL (Page Description Language) data, contained in a print job. Reference numeral 508 designates a job management unit that temporarily stores output attribute information including the number of pages to be printed by the print job and colors. Reference numeral 509 designates a print data interpretation unit. The print data interpretation unit 509 acquires print data from the print data storage unit 507 based on the output attribute information stored in the job management unit 508 and carries out an image generating process to thereby generate image data. Reference numeral 510 designates an image storage unit that temporarily stores image data generated by the print data interpretation unit 509 until completion of printing. Reference numeral 511 designates a printer engine. The printer engine 511 actually prints out image data stored in the image storage unit 510 on a medium, such as a print sheet, by the electrophotographic printing method or the inkjet printing method.

Next, a description will be given of the form of a print job.

A print job is formed by one or more job packets. A job packet is standardized to facilitate recognition of the start and end of the print job and configuration of the attributes of the print job.

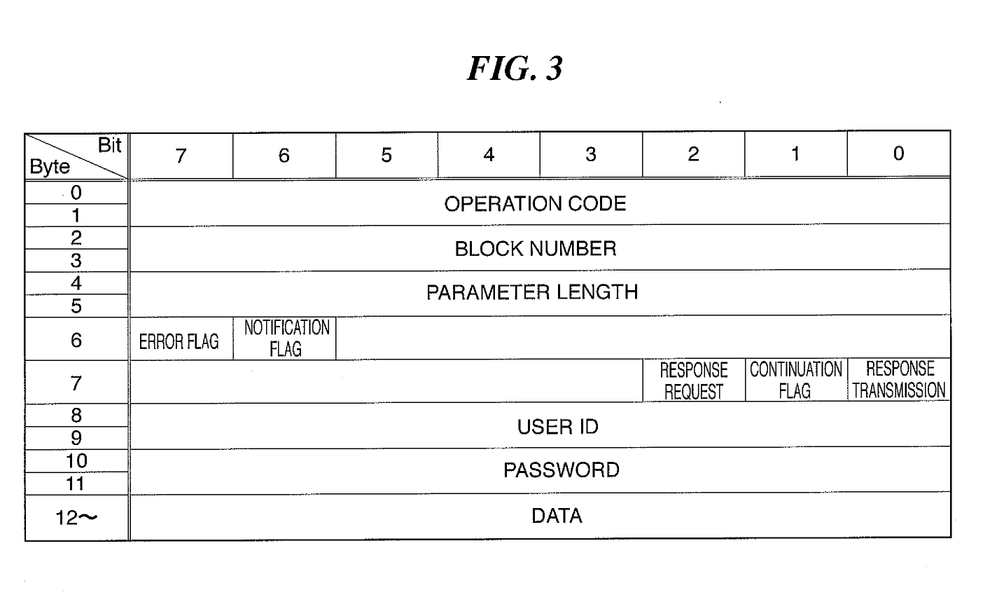

FIG. 3 is a view useful in explaining the internal configuration of a job packet.

As shown in FIG. 3, the ordinate represents bytes of the job packet, and the abscissa represents bits of each byte.

In FIG. 3, bytes 0 to 1 are assigned to an operation code which describes a 2-byte identification code indicative of the function of the job packet. The following codes are set as operation codes:

| | |
|---|---|
| 0x0201 | job start operation |
| 0x0202 | job attribute setting operation |
| 0x0204 | PDL data transmitting operation |
| 0x0205 | job end operation |
| 0x0301 | printing restriction information operation |

Bytes 2 to 3 are assigned to a block number. When a transmitting end of the job packet receives a response from a receiving end, the block number is used to identify a job packet associated with the response. For example, in a case where job packets having respective block numbers 1, 2, and 3 added thereto have been sequentially transmitted, when an error packet having the block number 2 added thereto is returned from the receiving end, the transmitting end can recognize that an error occurred in the job packet having the block number 2 added thereto.

Bytes 4 to 5 are assigned to a parameter length indicative of the byte length of a data section of the job packet. A length of 0 to 64 Kbytes can be specified.

Bytes 6 to 7 are assigned to a field specifying various kinds of flags of a job packet. The flags indicate the following facts, respectively.

Error flag: This flag indicates, when set to 1, that some error has occurred in the printing apparatus 403. The error flag is added to a return packet sent from the printing apparatus 403 to a print instructing end.

Notification flag: This flag indicates, when set to 1, that the packet is not a response to a request packet from the print instructing end, but contains some notification which the printing apparatus 403 has delivered to the print instructing end.

Continuation flag: This flag indicates, when set to 1, that since the data section of the job packet cannot contain all data, the remaining data will follow in the next job packet. In the next job packet, there is set the same operation code as that set in the present job packet, i.e. the job packet preceding the next job packet.

Response request: In a case where the print instructing end requests the printing apparatus 403 to transmit a response packet in response to the present job packet sent to the printing apparatus 403, the response request is set to 1. When a job packet contains the response request set to 0, the printing apparatus 403 receiving the same is not required to transmit a response packet. However, whenever an error occurs in the printing apparatus 403, a response packet with the error flag set to 1 is sent to the print instructing end, irrespective of whether the response request of the received job packet is set to 0 or 1.

Response transmission: When the job packet is a response packet transmitted from the printing apparatus 403 to the print instructing end, the response transmission in the response packet is set to 1.

Bytes 8 to 9 are assigned to a user ID field, and bytes 10 to 11 to a password field. When a job packet concerns printing, and when printing restriction is to be set on the printing, a user ID and a password for authentication are recorded in the user ID and the password fields of the job packet, respectively. In the job packet shown in FIG. 3, the user ID and password fields are not used.

Bytes 12 et seq. are assigned to a data section for storing data corresponding to an operation code. When the operation code is the job start operation or the job end operation, no data is stored in the data section.

When the operation code is indicative of the job attribute setting operation, job attribute IDs desired to be set and associated job attribute values are stored in the data section of the bytes 12 et seq. A job attribute ID is an identifier provided in association with a job attribute or a job environment. IDs are assigned in advance to respective job attributes prescribed by the ISO-10175 (DPA) (ISO: International Standardization Organization). Typical job attribute IDs are listed below.

Job Attribute ID

| | |
|---|---|
| 0x0101 | job name |
| 0x0103 | job owner name |
| 0x016a | job size |
| 0x0174 | number of pages to be printed |

Besides, job attributes, such as the number of pages to be printed and monochrome/color, and respective associated IDs can be assigned depending on the capabilities of the printing apparatus.

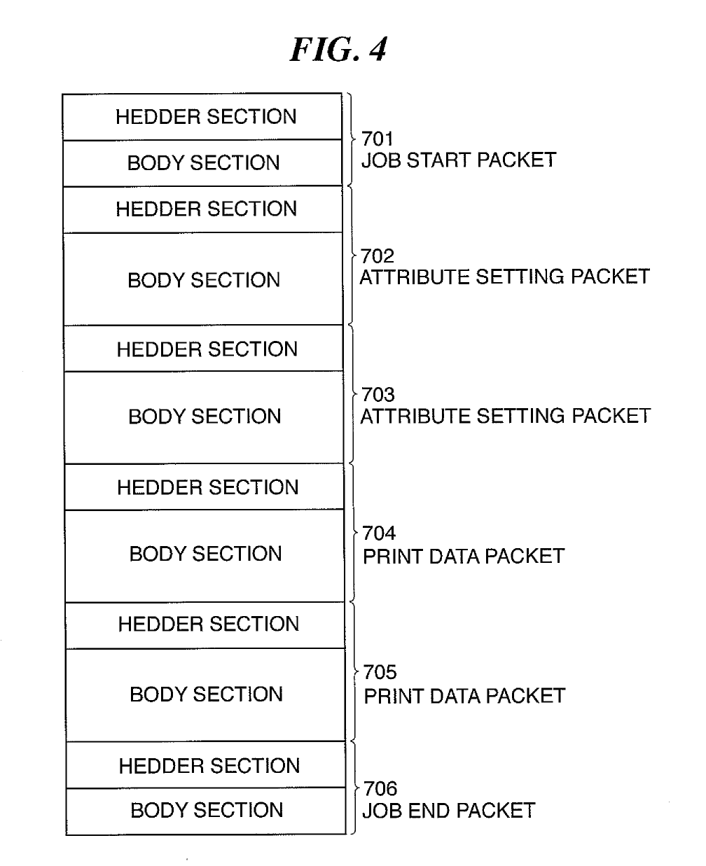

FIG. 4 is a view useful in explaining the configuration of a print job without printing restriction information. It should be noted that the view is schematized for purposes of simplicity of description.

As shown in FIG. 4, a print job is comprised of a plurality of job packets each formed by a header section and a body section. The job packets of a print job are transmitted from a print instructing end to the printing apparatus 403 sequentially from the top, as viewed in FIG. 4. The header section of each job packet corresponds to the areas of the bytes 0 to 11 in FIG. 3, and the body section corresponds to the area of the bytes 12 et seq.

Referring to FIG. 4, a job start packet 701 is a job packet that declares the start of a job, and the operation code of the bytes 0 to 1 thereof is set to 0x0201 indicative of the job start operation.

Each of attribute setting packets 702 and 703 is a job packet that sets the job name, the owner name, or a print condition of the print job. The operation code of the bytes 0 to 1 is set to 0x0202 indicative of the job attribute setting operation. When setting a plurality of attributes, a plurality of attribute setting packets are set, as shown in FIG. 4.

Each of print data packets 704 and 705 is a job packet that transmits print data. The operation code of the bytes 0 to 1 is set to 0x0204 indicative of the PDL data transmitting operation. When transmitting a plurality of PDL data, a plurality of print data packets are set, as shown in FIG. 4.

A job end packet 706 is a job packet indicating the end of a job, and the operation code of the bytes 0 to 1 is set to 0x0205 indicative of the job end operation. After receiving the job end packet 706, the printing apparatus 403 can display a message indicative of the end of a printing operation on an operating screen of the printing apparatus 403, and shift to processing for ending the job.

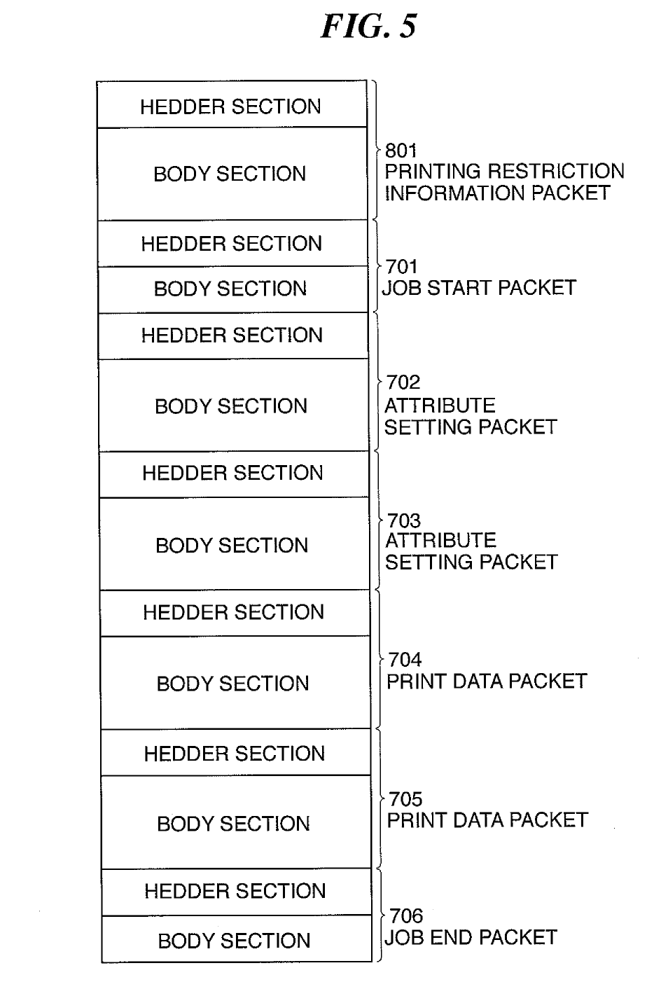

FIG. 5 is a view useful in explaining the configuration of a print job with printing restriction information added thereto. It should be noted that this configuration is basically the same as that of the print job shown in FIG. 4, and therefore, identical sections are designated by the same reference numerals, while omitting description thereof.

In the print job configuration shown in FIG. 5, a printing restriction information packet 801 is added to the leading end of the print job. The operation code of the bytes 0 to 1 of the printing restriction information packet 801 is set to 0x0301 indicative of the printing restriction information operation. It should be noted that in a job packet having the printing restriction information operation designated therein, printing restriction information is described in the data section of the bytes 12 et seq.

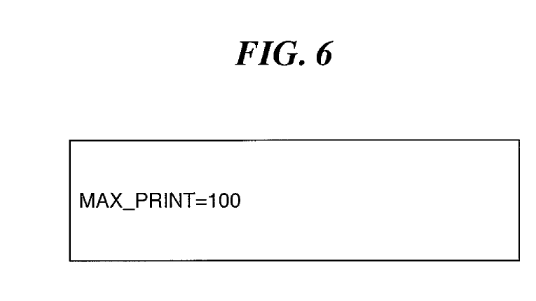

FIG. 6 is a view showing an example of a format of the printing restriction information.

In FIG. 6, a character string “MAX_PRINT” indicates an upper limit value of the number of sheets that can be output by the associated print job and a part “=100” indicates a value set to the upper limit value, whereby it is indicated that the upper limit value of the number of printable sheets is equal to 100. It should be noted that this printing restriction information is shown only by way of example, and a plurality of pieces of printing restriction information may be specified in a plurality of lines, respectively.

Now, it is required to verify whether the printing restriction information was read from an authorized authentication server. This verification is performed by making use of a digital signature. In the following, a description will be given of the verification.

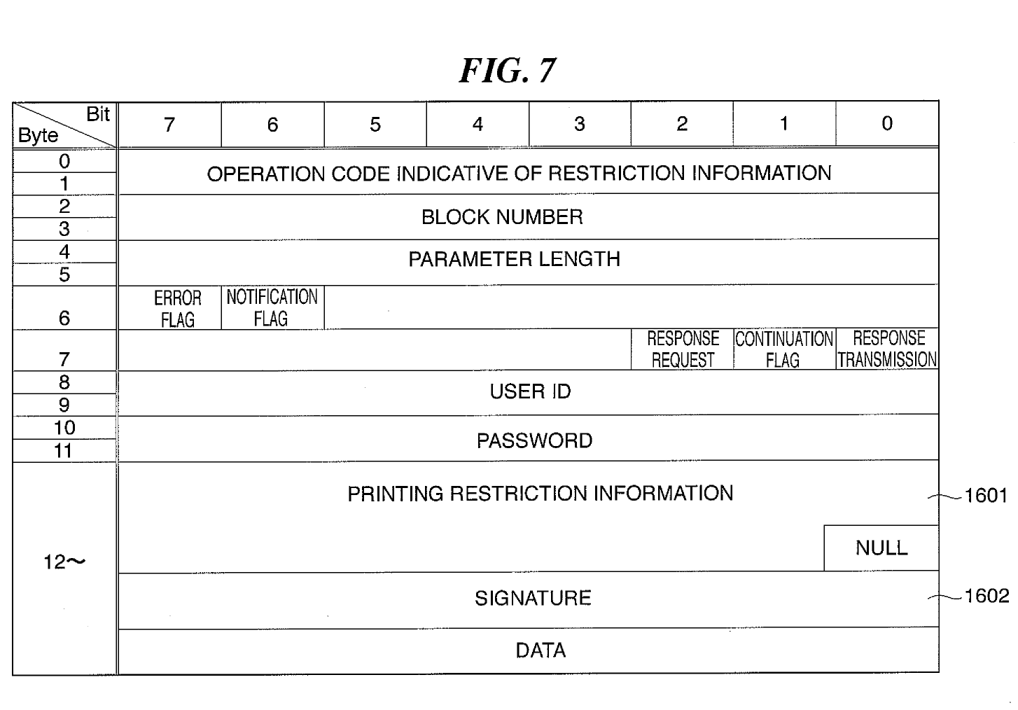

FIG. 7 is a view of a print job packet with entries of printing restriction information.

In FIG. 7, the bytes 0 to 11 are the header section, and the bytes 12 et seq. are the data section. In the data section, printing restriction information is described in an area 1601 from the leading end of the data area to a character string “NULL”. For example, the printing restriction information shown in FIG. 6 is described in the area 1601. A digital signature is written in a 128-byte area 1602 following the area 1601. This digital signature assures that the printing restriction information described in the area 1601 has been read out from an authorized server and has not been tampered during the transmission. The digital signature is compliant e.g. with the RSA public-key cryptosystem. In the digital signature compliant with the RSA public-key cryptosystem, a message digest is generated by a one-way function from a signature object (printing restriction information in the present case), and the digest is encrypted by an issuing end (e.g. the authentication server 402) using its own secret key. Then, the printing apparatus 403 verifies the signature object using a public key. The secret key is owned by the authorized server alone, and if the signature object is successfully verified using a proper public key, it can be proved that the signature object is authentic.

The public key used for verification of the digital signature is generated utilizing a public key pair owned by the authorized server, and passed in advance from the server to the printing apparatus 403 prior to printing. To pass the public, it can be envisaged to employ a method of third party verification using a public key infrastructure (PKI) in the case where a network is used, or a method of physical delivery using a memory card, and in the present embodiment, either of the two methods may be employed.

By the way, whether or not to permit printing is defined as a policy (operation policy) of an office (administrator). In a case where the office employs strict printing restriction, execution of printing based on a print job, as shown in FIG. 4, which does not contain the printing restriction information must not be permitted. On the other hand, if printing restriction has only to be imposed on specific users while preserving compatibility with the conventional printing function, execution of printing based on a print job, as shown in FIG. 4, which does not contain the printing restriction information may be permitted. The operation policy can be configured only by the administrator of the printing system via the operating section (GUI unit 506) of the printing apparatus 403.

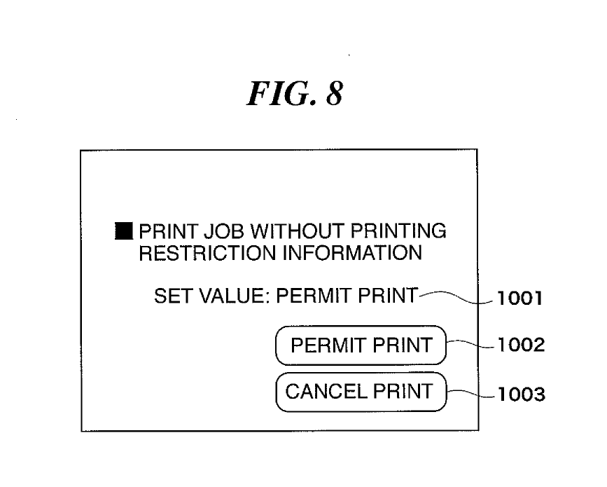

FIG. 8 is a view of a GUI screen displayed when a user configures the operation policy via the operating section (GUI unit 506).

The GUI screen is displayed only when a user having an administrator authority succeeds in authentication by a well-known authentication mechanism using a password, an IC card, or the like. Since the authentication mechanism is known, the description thereof is omitted.

Referring to FIG. 8, a state-indicative character string 1001 indicates that the value currently set to “print job without printing restriction information” is set to “permit print”. A button 1002 is pressed for changing the setting to “permit print” (for maintaining the current setting, in the case shown in FIG. 8), while a button 1003 is pressed for changing the setting to “cancel print”.

The setting is recorded in a nonvolatile memory (not shown) provided in the printing apparatus 403, whereby the policy of the printing apparatus 403 kept preserved.

Next, a description will be given of a print job-receiving process which is executed by the printing apparatus 403.

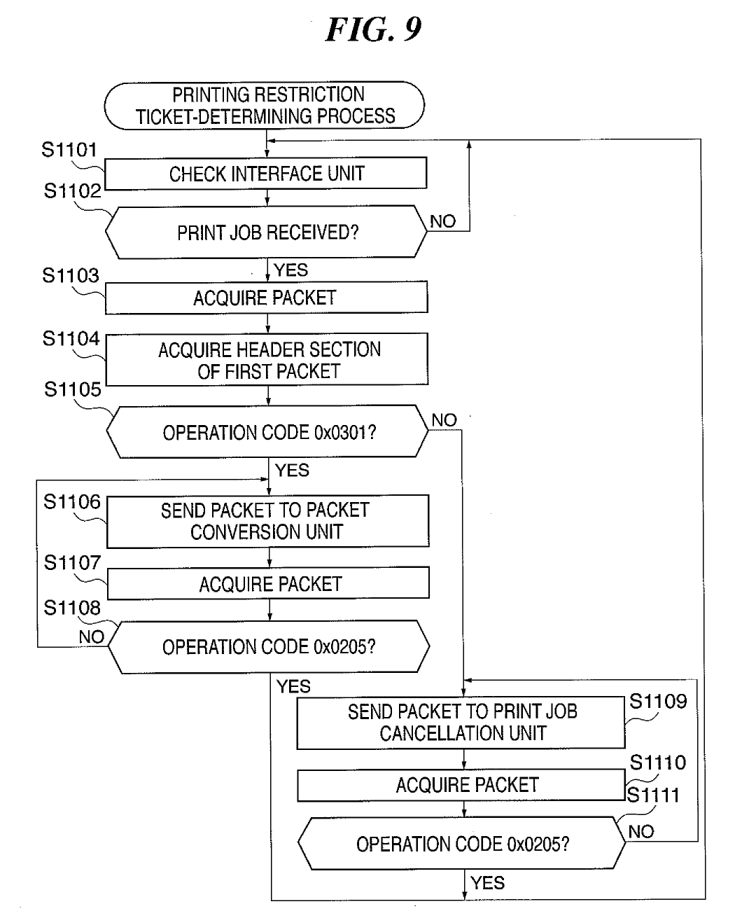

FIG. 9 is a flowchart of a printing restriction ticket-determining process which is executed by the printing restriction ticket-determining unit 502 appearing in FIG. 2.

The printing restriction ticket-determining process is started upon the start of the printing apparatus 403 and is continued until the power of the printing apparatus 403 is turned off.

First, in a step S1101, the printing restriction ticket-determining unit 502 checks the interface unit 501. If the interface unit 501 has not received a print job (NO to S1102), the process returns to the step S1101, wherein the interface unit 501 is checked again. On the other hand, if a print job has been received (YES to S1102), the process proceeds to a step S1103, wherein the first one of the series of job packets shown in FIG. 4 or 5 is acquired, and in the following step S1104, the header section of the acquired job packet is acquired.

Then, in a step S1105, an operation code in the acquired header section of the job packet is determined. If the operation code is 0x0301 indicative of the printing restriction information operation (YES to S1105, in the case of the job packet shown in FIG. 5), the process proceeds to a step S1106, wherein the acquired job packet is sent to the packet conversion unit 504. Thus, an instruction associated with the print job is modified based on the printing restriction information and then sent to the packet conversion unit 504.

Thereafter, in a step S1107, one of the second and succeeding ones of the series of job packets shown in FIG. 4 or 5 is acquired. Then, in a step S1108, an operation code in the acquired header section of the acquired job packet is determined. If the operation code is 0x0205 indicative of the job end operation (YES to S1108), the process returns to the step S1101. On the other hand, if the operation code is not indicative of the job end operation (NO to S1108), the process returns to the step S1106, wherein the acquired job packet is sent to the packet conversion unit 504.

If it is determined in the step S1105 that the operation code is not indicative of the printing restriction information operation (NO to S1105, in the case of the job packet shown in FIG. 4), it is recognized that the operation code is indicative of the job start operation, and the process proceeds to a step S1109. In the step S1109, the printing restriction ticket-determining unit 502 sends the acquired job packet to the print job cancellation unit 505. This instructs the cancellation of print associated with the print job without printing restriction information.

Thereafter, in a step S1110, one of the second and succeeding ones of the series of job packets shown in FIG. 4 or 5 is acquired. Then, in a step S1111, an operation code in the header section of the acquired job packet is determined. If the operation code is 0x0205 indicative of the job end operation (YES to S1111), the process returns to the step S1101. On the other hand, if the operation code is not indicative of the job end operation (NO to S1111), the process returns to the step S1109, wherein the acquired job packet is sent to the print job cancellation unit 505.

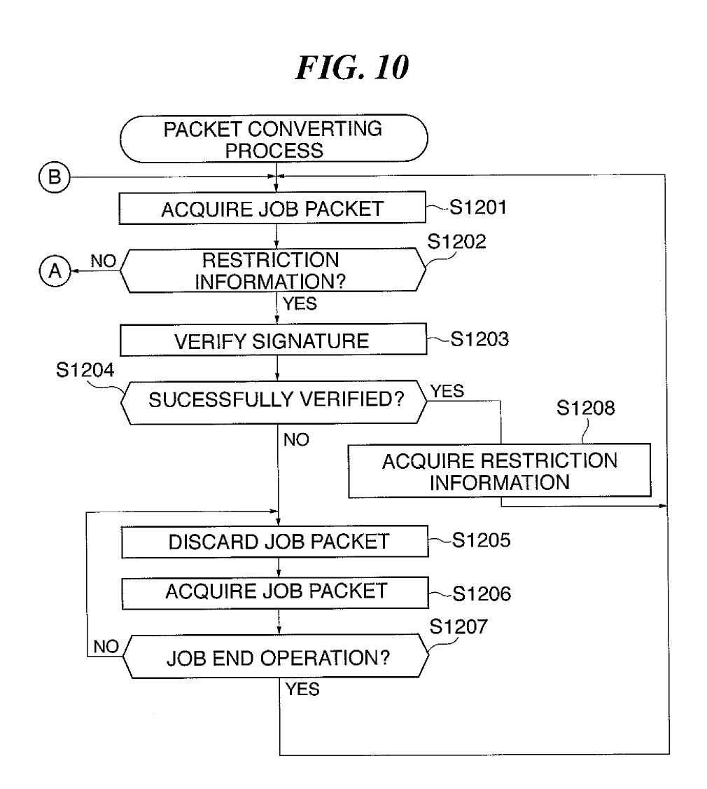

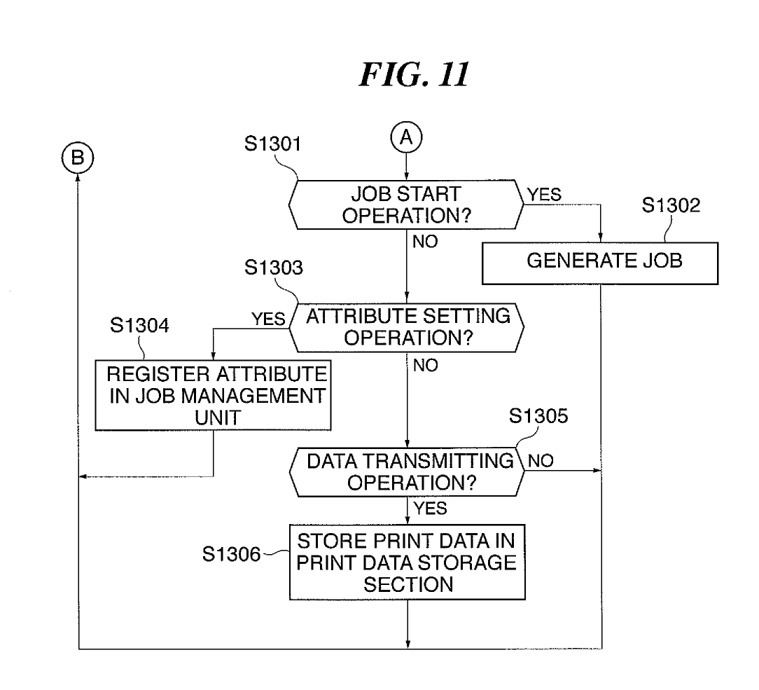

FIGS. 10 and 11 are a flowchart of a packet converting process which is executed by the packet conversion unit 504 appearing in FIG. 2.

The packet converting process is started upon the start of the printing apparatus 403 and is continued until the power of the printing apparatus 403 is turned off. It should be noted that a print job comprised of the series of job packets, shown in FIG. 5, which contain printing restriction information is transferred from the printing restriction ticket-determining unit 502 to the packet conversion unit 504.

First, in a step S1201, the packet conversion unit 504 acquires one of the series of job packets containing the printing restriction information and transferred from the printing restriction ticket-determining unit 502. In a step S1202, the operation code area of the acquired job packet is checked to determine whether or not the operation code 0x0301 indicative of the printing restriction information operation is recorded therein. If the operation code 0x0301 is recorded in the operation code field (YES to S1202), the process proceeds to a step S1203, wherein the packet conversion unit 504 verifies a digital signature using a public key acquired in advance. If the digital signature is successfully verified (YES to S1204), the process proceeds to a step S1208, wherein the printing restriction information is acquired and stored. Then, the process returns to the step S1201.

If verification fails (NO to S1204), the process proceeds to a step S1205, wherein the job packet is discarded. In the following step S1206, a next job packet of the series of job packets is acquired. Then, it is determined in a step S1207 whether or not the operation code of the acquired job packet is indicative of the job end operation. If the operation code is indicative of the job end operation (YES to S1207), the process returns to the step S1201, and processing is continued. On the other hand, if the operation code is not indicative of the job end operation (NO to S1207), the process returns to the step S1205, wherein the job packet is discarded. Thus, when verification of the digital signature fails, the series of job packets are sequentially discarded until the job end of the print job.

If it is determined in the step S1202 that the printing restriction information operation code is not recorded in the acquired job packets, the process proceeds to a step S1301. This means that one of the job packets, shown in FIG. 5, from the job start packet 701 to the job end packet 706 has been acquired.

First, it is determined in the step S1301 whether or not the operation code of the acquired job packet is the job start operation 0x0201. If the operation code is the job start operation 0x0201 (YES to S1301), the process proceeds to a step S1302, wherein a new job is generated by securing an area for the print job on the job management unit 508 and assigning a job identifier to the area. Then, the process returns to the step S1201.

On the other hand, if the operation code is not the job start operation 0x0201 (NO to S1301), the process proceeds to a step S1303, wherein it is determined whether or not the operation code of the acquired job packet is the job attribute setting operation 0x0202. If the operation code is the job attribute setting operation 0x0202 (YES to S1303), the process proceeds to a step S1304, wherein the attribute value is set in an attribute area for the print job on the job management unit 508. Then, the process returns to the step S1201.

On the other hand, if the operation code is not the job attribute setting operation 0x0202 (NO to S1303), the process proceeds to a step S1305, wherein it is determined whether or not the operation code of the acquired job packet is the PDL data transmitting operation 0x0204. If the operation code is the PDL data transmitting operation 0x0204 (YES to S1305), the process proceeds to a step S1306, wherein print data is stored in the print data storage unit 507. Then, the process returns to the step S1201. If it is determined in the step S1305 that the operation code is not the PDL data transmitting operation 0x0204 (NO to S1305), the process immediately returns to the step S1201.

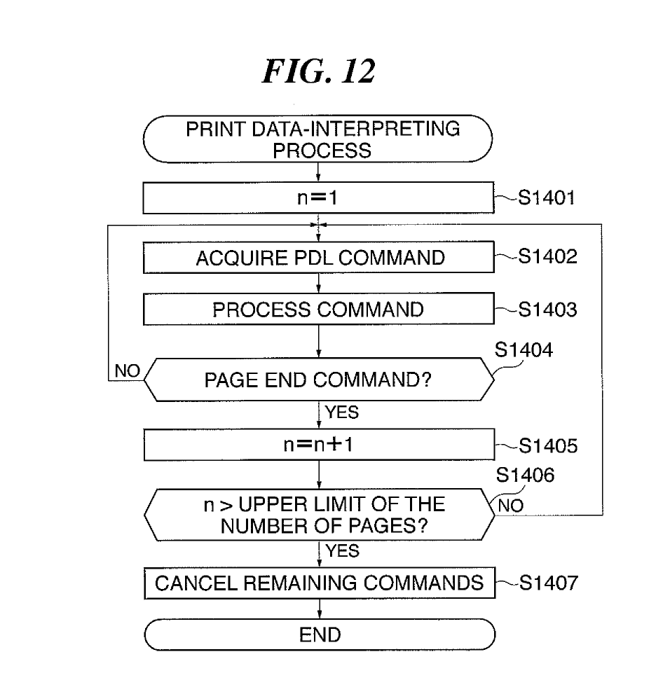

FIG. 12 is a flowchart of a print data-interpreting process which is executed by the print data interpretation unit 509 appearing in FIG. 2.

This print data-interpreting process is started upon reception of the print job, and is continued until the interpretation of the last page of the print job is completed.

The print data interpretation unit 509 interprets a PDL language and generates image data for use in actual printing. As the PDL language, there have been put into practical use various types including PostScript and LIPS.

Referring to FIG. 12, first in a step S1401, the print data interpretation unit 509 initializes a variable n indicative of the number of pages to 1. Then, in a step S1402, a PDL command is acquired from the print data storage unit 507, and in a step S1403, processing is carried out according to the acquired PDL command. Now, as the PDL command, there is assumed here a command for actual drawing, such as “rectangle drawing” or “image drawing” in LIPS.

In a step S1404, it is determined whether or not the PDL command according to which processing was carried out in the step S1403 was a page end command. If it is determined that the PDL command was a page end command, the process proceeds to a step S1405, whereas if not, the process returns to the step S1402.

In the step S1405, the print data interpretation unit 509 increments the variable n by 1. In the following step S1406, it is determined whether or not the variable n has exceeded an upper limit of the number of pages indicated by the printing restriction information acquired in the step S1208. If the variable n has not exceeded the upper limit of the number of pages, the process returns to the step S1402. On the other hand, if the variable n has exceeded the upper limit of the number of pages, the process proceeds to a step S1407, wherein the other commands are all discarded. In the example shown in FIG. 6, the maximum number of printable sheets is set to 100, and hence, at the time point the page end command of the print data has been detected one hundred times, the other commands are all discarded, thereby causing no printing to be executed any further.

Next, a description will be given of a process associated with a print job to which printing restriction information is not attached.

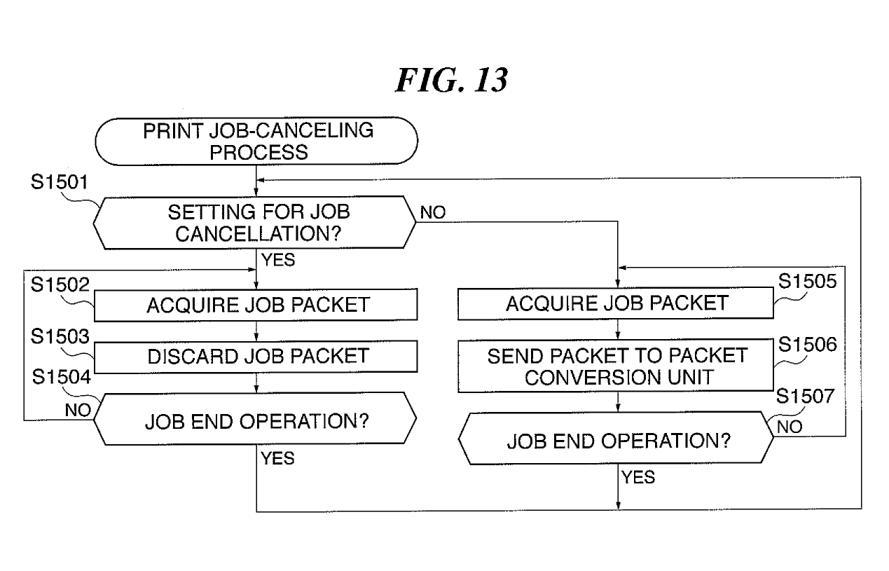

FIG. 13 is a flowchart of a print job-canceling process which is executed by the print job cancellation unit appearing in FIG. 2.

The print job-canceling process is started upon the start of the printing apparatus 403 and is continued until the power of the printing apparatus 403 is turned off. It should be noted that a print job comprised of the series of job packets, shown in FIG. 4, which do not contain printing restriction information is transferred from the printing restriction ticket-determining unit 502 to the print job cancellation unit 505.

First, it is determined in a step S1501 whether or not it is configured such that a print job without printing restriction information is canceled. This determination is performed based on whether or not the state-indicative character string 1001 has been set to “cancel print” by depressing the button 1003 appearing in FIG. 8. If the state-indicative character string 1001 has been set to “cancel print”, it is judged that cancellation is set, and the process proceeds to a step S1502, whereas if the set value has been set to “permit print”, the process proceeds to a step S1505.

In the step S1502, one job packet of the series of job packets without printing restriction information is acquired, and in a step S1503, the acquired job packet is discarded. Then, it is determined in a step S1504 whether or not the operation code of the discarded job packet was indicative of the job end operation. If the operation code was indicative of the job end operation (YES to S1504), the process returns to the step S1501, whereas if not (NO to S1504), the process returns to the step S1502.

On the other hand, in the step S1505, one of the series of job packets without printing restriction information is acquired, and in a step S1506, the acquired job packet is transferred to the packet conversion unit 504. Then, it is determined in a step S1507 whether or not the operation code of the transferred job packet was indicative of the job end operation. If the operation code was indicative of the job end operation (YES to S1507), the process returns to the step S1501, whereas if not (NO to S1507), the process returns to the step S1505.

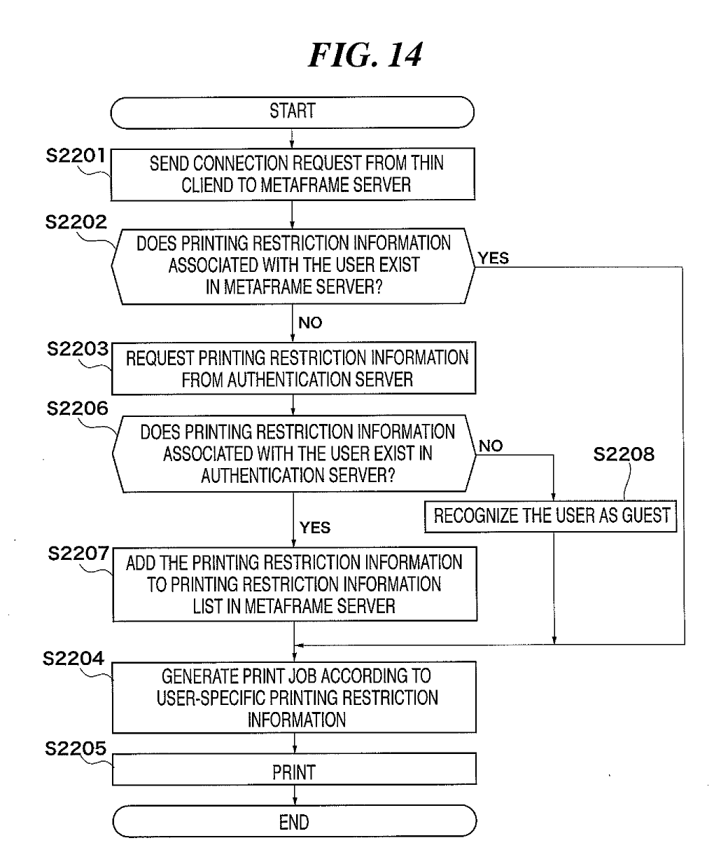

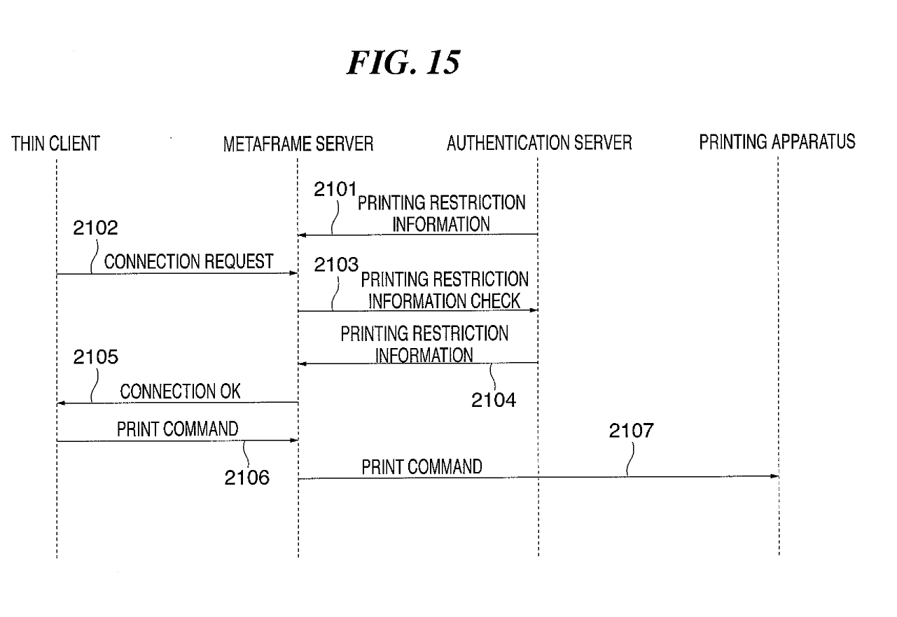

Next, the operation of the printing system shown in FIG. 1 will be described with reference to FIGS. 14 and 15.

FIG. 14 is a flowchart showing a flow of first operations of the respective apparatuses forming the printing system shown in FIG. 1. The first operations constitute the operation of the printing system when printing is performed.

In the printing system shown in FIG. 1, the thin client 405 transmits a connection request with a user designated therein to the metaframe server 401 (S2201). It should be noted that user-specific printing restriction information has been sent in advance from the authentication server 402 to the metaframe server 401, and a user-specific printing restriction information list generated based on the user-specific printing restriction information received from the authentication server 402 is stored in the metaframe server 401. However, in the present system, users who are not under the management of the metaframe server 401 are also permitted to access the metaframe server 401. Insofar as a user is under the management of the authentication server 402, even if not under management of the metaframe server 401, the user is permitted to carry out print processing as a guest user. Further, the authentication server 402 can be accessed for authentication, not only by the metaframe server 401, but also by various kinds of terminal units.

Upon reception of the connection request in the step S2201, the metaframe server 401 checks whether or not the user of the thin client 405 is registered in the user-specific printing restriction information list held by the metaframe server 401 (S2202). If the user is registered in the list (YES to S2202), the process proceeds to a step S2204, whereas if not (NO to S2202), the process proceeds to a step S2203.

In the step S2204, the metaframe server 401 generates a print job according to printing restriction information associated with the user and sends the generated print job to the printing apparatus 403. Then, in a step S2205, the printing apparatus 403 carries out printing according to the received print job.

In the step S2203, the metaframe server 401 requests the authentication server 402 to check whether or not the printing restriction information associated with the user is stored in the database of the authentication server 402. The authentication server 402 checks the database in response to the request (S2206). If the printing restriction information is stored in the database (YES to S2206), the process proceeds to a step S2207, whereas if not (NO to S2206), the process proceeds to a step S2208.

In the step S2207, the printing restriction information associated with the user is sent from the authentication server 402 to the metaframe server 401, and is added to the user-specific printing restriction information list held by the metaframe server 401. Then, the process proceeds to the step S2204.

In the step S2208, the user is regarded as a guest user. Then, in the step S2204, a print job is generated according to printing restriction information which is set for a guest user based on a security policy.

It should be noted that the addition of printing restriction information to a print job may be executed by the metaframe server 401 as well as by the printing apparatus 403.

FIG. 15 is a sequence diagram showing transmission/reception of signals performed between the apparatuses in the printing system, when printing is performed. This sequence corresponds to the flowchart shown in FIG. 14.

First, having the power turned on, each of the authentication server 402 and the metaframe server 401 compares the user-specific printing restriction information of its own with that of the other's. Then, the authentication server 402 sends user-specific printing restriction information which is not stored in the metaframe server 401 to the metaframe server 401 (2101).

Although in the present embodiment, comparison and update of the user-specific printing restriction information is performed when the power is turned on, this is not limitative, but the comparison and update may be performed at predetermined intervals. Further, it is assumed that the user-specific printing restriction information is stored in a memory area which is not lost even after the power of the metaframe server 401 is turned off.

The thin client 405 transmits a connection request (2102) so as to establish connection to the metaframe server 401 for printing. If a user account used for log-in exists in the user-specific printing restriction information list held by the metaframe server 401, the metaframe server 401 sends a status indicative of “connection OK” to the thin client 405 (2105). In this case, information exchange in sequences 2103 and 2104 is omitted.

If the user account used for log-in does not exist in the user-specific printing restriction information list held by the metaframe server 401, the metaframe server 401 requests the authentication server 402 to check whether or not the authentication server 402 stores printing restriction information associated with the user (2103). If the authentication server 402 does not store printing restriction information associated with the user, the user of the thin client 405 is treated as a “guest” user. If the authentication server 402 stores printing restriction information associated with the user, the authentication server 402 sends the printing restriction information to the metaframe server 401 (2104), and the metaframe server 401 registers the same in the user-specific printing restriction information list.

Then, the metaframe server 401 sends the “connection OK” status to the thin client 405 (2105). The thin client 405 sends a print command to the metaframe server 401 (2106), and the metaframe server 401 adds the printing restriction information to a print job and sends the print job together with the print command to the printing apparatus 403 (2107). Thus, the printing apparatus 403 carries out printing according to the print job containing the printing restriction information.

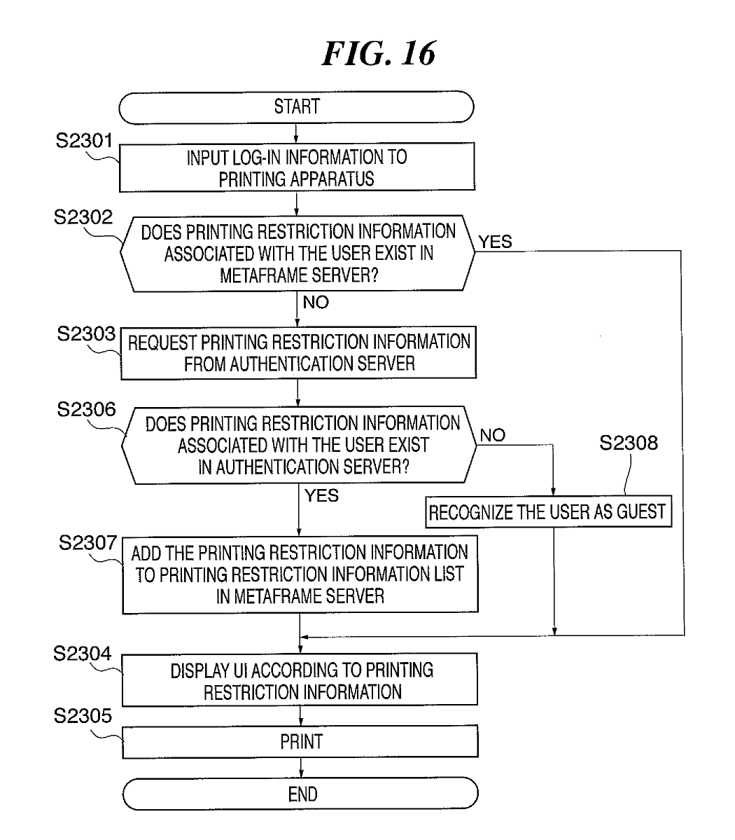

FIG. 16 is a flowchart showing a flow of second operations of the respective apparatuses forming the printing system shown in FIG. 1. The second operations constitute the operation of the printing system when printing (copying) is performed by the printing apparatus 403 based on image data obtained by scanning an original. The original may be scanned by a reader unit provided in the printing apparatus 403 or by a scanner (not shown) connected to the network 404. In the following, a description will be given of a case where the printing apparatus 403 is a copying machine equipped with a reader unit, and is operated via the operating screen of the GUI unit 506 of the printing apparatus 403.

In the printing system shown in FIG. 1, a user inputs a user ID and a password for log-in to the printing apparatus 403, via the operating screen of the printing apparatus 403 (S2301). It should be noted that user-specific printing restriction information has been sent in advance from the authentication server 402 to the metaframe server 401, and a user-specific printing restriction information list generated based on the user-specific printing restriction information received from the authentication server 402 is stored in the metaframe server 401.

The metaframe server 401 checks whether or not the user identified by the user ID and the password is registered in the user-specific printing restriction information list held thereby (S2302). If the user is registered (YES to S2302), the process proceeds to a step S2304, whereas if not (NO to S2302), the process proceeds to a step S2303.

In the step S2304, a printing function limited based on printing restriction information associated with the user is displayed on the operating screen of the printing apparatus 403. Then, in a step S2305, the user configures settings on the operation of the printing apparatus 403 via the operating screen of the printing apparatus 403, and the printing apparatus 403 performs printing according to the settings.

In the step S2303, the metaframe server 401 requests the authentication server 402 to check whether or not the printing restriction information associated with the user identified by the user ID and the password exists in the database of the authentication server 402. The authentication server 402 checks the database in response to the request (S2306). If the printing restriction information exists in the database (YES to S2306), the process proceeds to a step S2307, whereas if not (NO to S2306), the process proceeds to a step S2308.

In the step S2307, the printing restriction information associated with the user is sent from the authentication server 402 to the metaframe server 401, and is added to the user-specific printing restriction information list held by the metaframe server 401. Then, the process proceeds to the step S2304.

In the step S2308, the user is regarded as a guest user. Then, in the step S2304, a printing configuration screen which is configured for a guest user, based on the security policy, is displayed on the operating screen of the printing apparatus 403.

Now, a procedure in the present embodiment, by which the printing apparatus 403 consults the metaframe server 401, for confirmation of printing restriction information will be described while making a comparison with a conventional procedure.

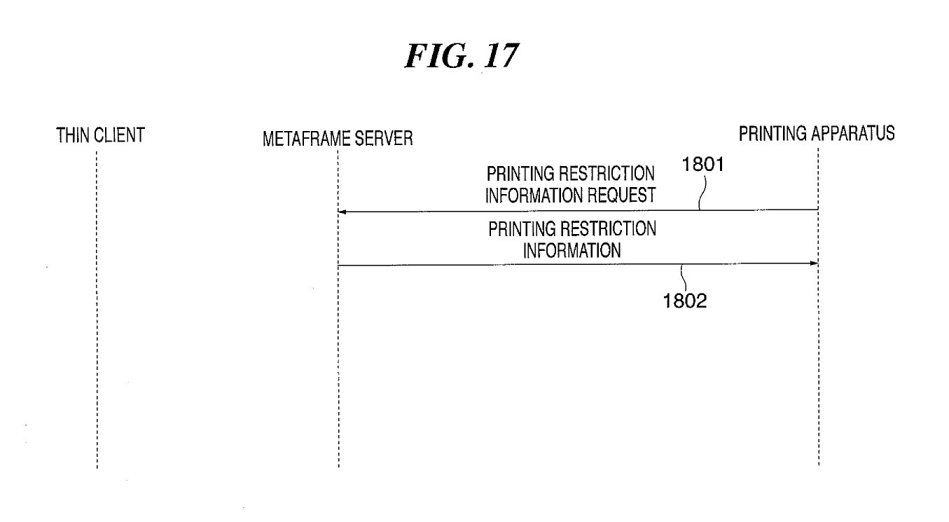

FIG. 17 is a sequence diagram showing transmission/reception of signals performed between apparatuses forming a printing system which does not include an authentication server.

In this system, a printing apparatus requests a metaframe server to send printing restriction information associated with a designated user (1801), and in response to this request, the metaframe server sends the printing restriction information to the printing apparatus (1802).

This system makes it possible to set printing restriction on a print instruction (e.g. for copying) from the printing apparatus, based on user-specific printing restriction information managed by the metaframe server.

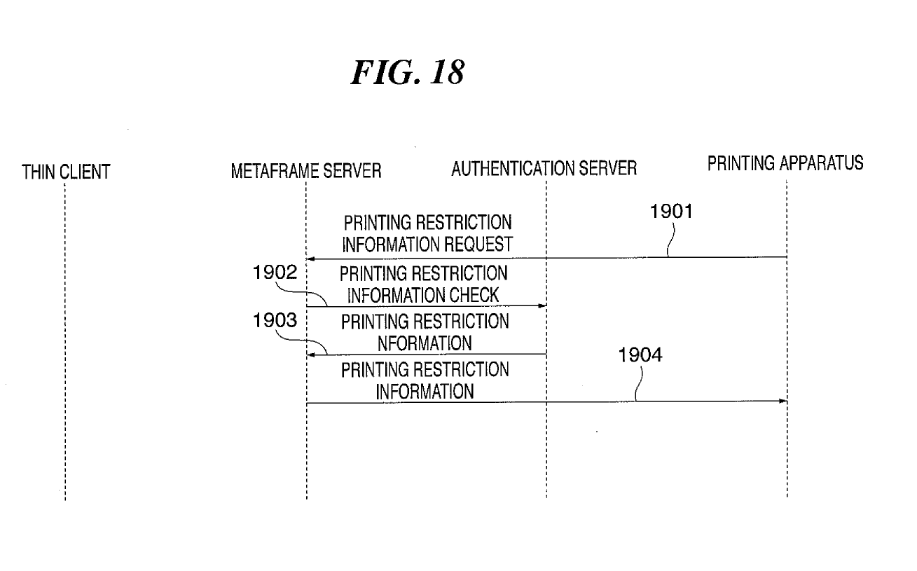

FIG. 18 is a sequence diagram showing transmission/reception of signals performed between the apparatuses in the printing system according to the present embodiment, which includes the authentication server.

In this system, the printing apparatus 403 requests the metaframe server 401 to send printing restriction information associated with a designated user (1901). In response to this request, the metaframe server 401 determines whether or not the printing restriction information associated with the user exists in the user-specific printing restriction information list held by the metaframe server 401 itself. If the printing restriction information does not exist, the metaframe server 401 requests the authentication server 402 to check whether or not the printing restriction information associated with the user exists in the authentication server 402 (1902). Then, if the printing restriction information exists, the authentication server 402 sends the printing restriction information to the metaframe server 401 (1903). When receiving the printing restriction information, the metaframe server 401 sends the same to the printing apparatus 403 (1904).

As described above, according to the present embodiment, only when the printing restriction information associated with the user does not exist in the metaframe server 401, the metaframe server 401 requests the authentication server 402 to check the whether or not the printing restriction information associated with the user exists.

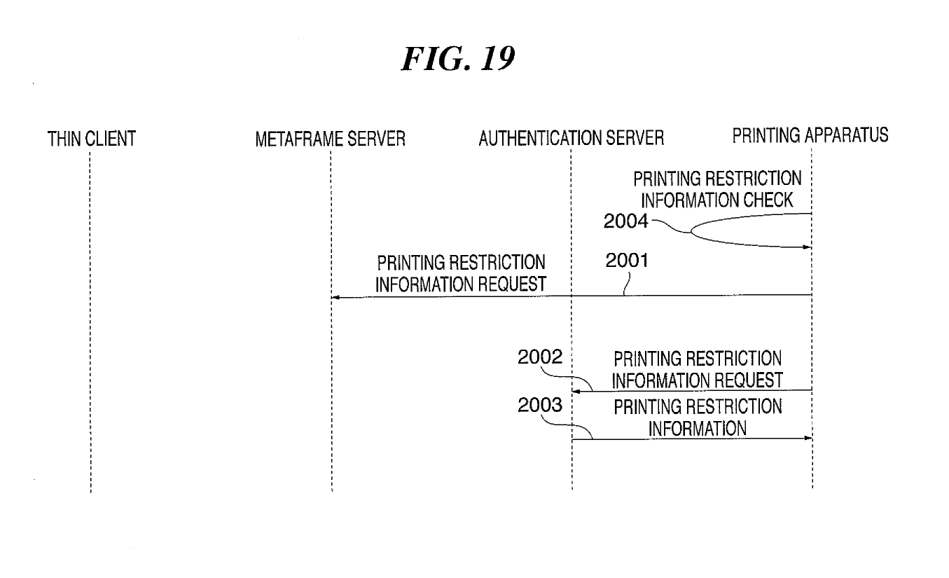

It should be noted that in a case where the printing apparatus 403 scans an image and carries out copying, the printing system may be configured such that operations shown in FIG. 19 are performed.

FIG. 19 is a sequence diagram showing transmission/reception of signals performed between the apparatuses in the printing system in a case where the printing apparatus 403 carries out scanning and copying.

First, when a user instructs the printing apparatus 403 to perform copying, the printing apparatus 403 detects printing restriction information associated with the user, based on user-specific printing restriction information held in the printing apparatus 403 itself (2004). If the printing restriction information associated with the user is not stored in the printing apparatus 403, the printing apparatus 403 inquires of the metaframe server 401 whether or not the printing restriction information exists in the metaframe server 401 (2001). In response to this inquiry, the metaframe server 401 checks with the authentication server 402 about the presence of the printing restriction information, and then sends a results of the inquiry to the printing apparatus 403. It should be noted that if there is no response from the metaframe server 401 even when a predetermined time period has elapsed after the inquiry was made, the printing apparatus 403 directly requests the printing restriction information associated with the user from the authentication server 402 (2002), and acquires the same (2003).

Next, a description will be given of a second embodiment of the present invention.

The configuration of the second embodiment is basically the same as that of the first embodiment. Therefore, duplicate description of components corresponding to those in the first embodiment is omitted by designating them using the same reference numerals, and only different points from the first embodiment will be described.

The second embodiment is distinguished from the first embodiment in that the operation of the printing system when printing is performed is partially different from that shown in FIG. 14.

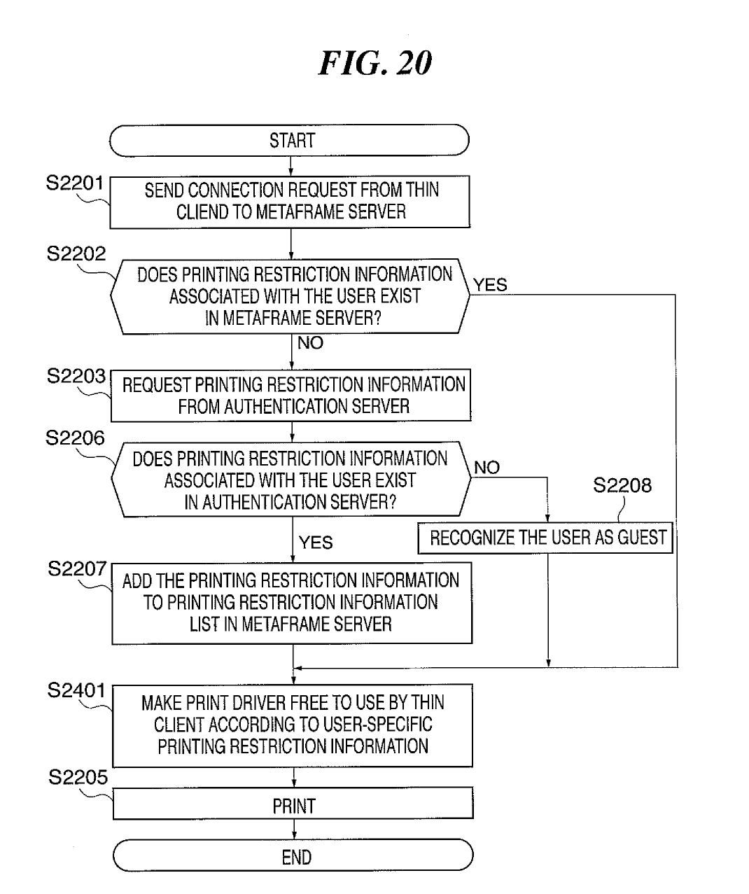

FIG. 20 is a flowchart showing a flow of operations carried out in the printing system according to the second embodiment, for printing. The flowchart in FIG. 20 is basically identical to that in FIG. 14 in the first embodiment. Therefore, steps identical to those in FIG. 14 are designated by identical step numbers, and description thereof is omitted.

In the second embodiment, a step S2401 is provided in place of the step S2204 in the flowchart of the first embodiment shown in FIG. 14.

More specifically, as is distinct from the step S2204 in the first embodiment, in which the metaframe server 401 generates the print job according to the printing restriction information associated with the user and sends the generated print job to the printing apparatus 403, in the step S2401 in the second embodiment, the metaframe server 401 makes a printer driver free to use by the thin client 405, which is limited in the functions that the user is permitted to use, based on the printing restriction information associated with the user. Thus, the thin client 405 is permitted to use the printer driver whose functions are limited, whereby printing restriction is set for the user.

According to the above described embodiments, since the processing for user-specific printing restriction can be shared by the metaframe server and the authentication server, it is possible to distribute processing load between the two servers. Further, in a case where printing restriction is configured by the metaframe server, authentication by the authentication server can be dispensed with, which makes it possible to enhance immediacy of print processing and processing efficiency. Furthermore, it is possible not only to enable a user who is not under the management of the metaframe server to carry out printing, but also to set printing restriction on the user. Thus, user-specific printing restriction can be executed while making the most of the features of the preservation of security and maintenance of clients in the printing system assuming that the printing system uses the metaframe server and the thin clients.

Although in the above described embodiments, printing restriction is described, it is to be understood that the present invention can be applied not only to printing, but also to other processing, such as transmission.

Further, it is to be understood that the object of the present invention may also be accomplished by supplying a system or an apparatus with a storage medium in which a program code of software, which realizes the functions of either of the above described embodiments is stored, and causing a computer (or CPU or MPU) of the system or apparatus to read out and execute the program code stored in the storage medium.

In this case, the program code itself read from the storage medium realizes the functions of either of the above described embodiments, and therefore the program code and the storage medium in which the program code is stored constitute the present invention.

Examples of the storage medium for supplying the program code include a floppy® disk, a hard disk, a magnetic-optical disk, an optical disk, such as a CD-ROM, a CD-R, a CD-RW, a DVD-ROM, a DVD-RAM, a DVD-RW, or a DVD+RW, a magnetic tape, a nonvolatile memory card, and a ROM. Alternatively, the program may be downloaded via a network.

Further, it is to be understood that the functions of either of the above described embodiments may be accomplished not only by executing the program code read out by a computer, but also by causing an OS (operating system) or the like which operates on the computer to perform a part or all of the actual operations based on instructions of the program code.

Further, it is to be understood that the functions of either of the above described embodiments may be accomplished by writing a program code read out from the storage medium into a memory provided on an expansion board inserted into a computer or a memory provided in an expansion unit connected to the computer and then causing a CPU or the like provided in the expansion board or the expansion unit to perform a part or all of the actual operations based on instructions of the program code.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2006-180233 filed Jun. 29, 2006, which is hereby incorporated by reference herein in its entirety.

What is claimed is:

1. A printing system including a thin client terminal, a control server for processing information based on a request from the thin client terminal, and a printing apparatus, which are interconnected by a network, comprising:
an authentication server connected to the network and configured to store printing restriction information concerning a print job on a user-by-user basis;
a determination unit provided in the control server and configured to determine, when a user of the thin client terminal gives a print instruction to the control server via the thin client terminal, whether or not printing restriction information associated with the user exists in the control server;
a transmission request unit provided in the control server and configured to request said authentication server to send the printing restriction information associated with the user, when said determination unit determines that the printing restriction information associated with the user does not exist in the control server; and
a print control unit provided in the control server and configured to cause the printing apparatus to carry out printing according to the printing restriction information sent from said authentication server in response to the request made by said transmission request unit.

2. A printing system as claimed in claim 1, wherein when a user of the printing apparatus gives a print instruction to the control server via the printing apparatus, said determination unit determines whether or not printing restriction information associated with the user exists in the control server.

3. A printing system as claimed in claim 2, wherein said print control unit includes:
a display unit configured to display, on an operating screen of the printing apparatus, a printing function limited based on the printing restriction information sent from said authentication server in response to the request made by said transmission request unit, and
a printing unit configured to cause the printing apparatus to carry out printing according to settings on the printing function displayed by said display unit, the settings being configured by the user of the printing apparatus.

4. A printing system as claimed in claim 2, further comprising an accepting unit provided in the control server and configured to accept user identification information input by the user, and
wherein said determination unit determines, based on the user identification information accepted by said accepting unit, whether or not printing restriction information associated with the user exists in the control server.

5. A printing system as claimed in claim 2, further comprising a request unit provided in the printing apparatus and configured to request said authentication server to send the printing restriction information associated with the user, in a case where the printing restriction information from said authentication server is not received via the control server even when a predetermined time period elapses after said transmission request unit made the request.

6. A print restricting method applied to a printing system including a thin client terminal, a control server for processing information based on a request from the thin client terminal, an authentication server for storing printing restriction information concerning a print job on a user-by-user basis, and a printing apparatus, which are interconnected by a network, comprising:
a determination step of the control server determining, when a user of the thin client terminal gives a print instruction to the control server via the thin client terminal, whether or not printing restriction information associated with the user exists in the control server;
a transmission request step of the control server requesting the authentication server to send the printing restriction information associated with the user, when it has been determined, in said determination step, that the printing restriction information associated with the user does not exist in the control server; and
a print control step of the control server causing the printing apparatus to carry out printing according to the printing restriction information sent from the authentication server in response to the request made in said transmission request step.

7. A print restricting method as claimed in claim 6, wherein when a user of the printing apparatus gives a print instruction to the control server via the printing apparatus, it is determined in said determination step whether or not printing restriction information associated with the user exists in the control server.

8. A print restricting method as claimed in claim 7, wherein said print control step includes:
a display step of displaying, on an operating screen of the printing apparatus, a printing function limited based on the printing restriction information sent from the authentication server in response to the request made in said transmission request step, and
a printing step of causing the printing apparatus to carry out printing according to settings on the printing function displayed in said display step, the settings being configured by the user of the printing apparatus.

9. A print restricting method as claimed in claim 7, further comprising an acceptance step of the printing apparatus accepting user identification information input by the user, and
wherein in said determination step, it is determined, based on the user identification information accepted in said acceptance step, whether or not printing restriction information associated with the user exists in the control server.

10. A print restricting method as claimed in claim 7, further comprising a request step of requesting the authentication server to send the printing restriction information associated with the user, in a case where the printing restriction information from the authentication server is not received via the control server even when a predetermined time period elapses after the request was made in said transmission request step.

11. A program for causing a computer to execute a print restricting method applied to a printing system including a thin client terminal, a control server for processing information based on a request from the thin client terminal, an authentication server for storing user-specific printing restriction information associated with a print job and a printing apparatus, which are interconnected by a network,
wherein the print restricting method comprises:
a determination step of the control server determining, when a user of the thin client terminal gives a print instruction to the control server via the thin client terminal, whether or not printing restriction information associated with the user exists in the control server;
a transmission request step of the control server requesting the authentication server to send the printing restriction information associated with the user, when it has been determined, in said determination step, that the printing restriction information associated with the user does not exist in the control server; and
a print control step of the control server causing the printing apparatus to carry out printing according to the printing restriction information sent from the authentication server in response to the request made in said transmission request step.
